(19) United States
(12) Patent Application Publication
(10) Pub. No.: US 2020/0034818 A1
(43) Pub. Date: Jan. 30, 2020

(54) SYSTEM AND METHOD FOR PERFORMING CASHLESS TRANSACTIONS BETWEEN COMPUTING DEVICES

(71) Applicant: SOURCE Ltd, Valletta (MT)

(72) Inventors: Moshe SELFIN, Haifa (IL); Ilya DUBINSKY, Kefar Sava (IL)

(73) Assignee: SOURCE Ltd, Valletta (MT)

(21) Appl. No.: 16/043,186

(22) Filed: Jul. 24, 2018

(51) Int. Cl. G06Q 20/32; G06Q 20/40

(52) U.S. Cl. CPC G06Q 20/3223; G06Q 20/3278; G06Q 20/4012

(57) ABSTRACT

Systems and methods of enabling a mobile computing device to perform a transaction using a first payment protocol and a second payment protocol, by executing a process on the mobile computing device, to communicate with a transaction platform executing a processor to associate a receipt of payment via the first payment protocol to the transaction platform with an account associated with the mobile computing device; receive from the transaction platform a temporary credential used for payment via the second payment protocol, the temporary credential funded based on the receipt of the payment to the transaction platform; contact a terminal via a communication protocol; and use the temporary credential to cause payment via the terminal.

### FIELD OF THE INVENTION

The present invention relates to systems and methods for cashless transactions that are carried out between computing devices.

### BACKGROUND OF THE INVENTION

In recent years, online payments have become common for transactions. However, such payments are only possible with businesses that allow online payments and cannot apply to some small businesses where a consumer is interested in a cashless purchase since there is no infrastructure (for both consumer and merchant) to carry out such a payment.

Some alternative payment methods include online wallets or payments with a mobile computing device using dedicated software (e.g., a payment app for smartphones) connected to a specific credit card and/or bank account of the user of the mobile computing device. The consumer can carry out payments at businesses with corresponding dedicated software and payment infrastructure to allow such payments, for example via the near field communication (NFC) protocol. For instance, a user may use the ApplePay service for a cashless payment for taxi rides via a smartphone payment app that is not specific to the taxi company, or any other business, and only allows online payments with the connected credit card and/or bank account. A cashless payment may be a payment without physical local currency (e.g. paper bills and metal coins); a cashless payment is typically carried out using a credit card, debit card, and services such as Apple Pay™, a mobile payment and digital wallet service.

In some cases, cashless consumer-merchant interactions (e.g., purchasing flowers from a flower shop or paying a restaurant bill) occur where the consumer does not have, or does not wish to use, a payment card that the merchant is able to accept. For instance, in some European countries most small businesses only accept national debit cards (e.g. acceptable only within the nation or jurisdiction in which the merchant is located) as means of cashless payment, such that a foreign tourist is unable to use an international credit card with the standard “EMV®” protocol (Europay, MasterCard and Visa) for example.

Therefore, typical tourists that travel abroad and carry a mobile computing device (e.g., a smartphone or tablet) and have some cashless payment method at their disposal, such as a foreign credit card, a bank account or an online eWallet, may not be able to perform cashless payments at businesses that do not accept foreign credit cards for instance.

### SUMMARY

There is thus provided, in accordance with some embodiments, a method of enabling a mobile computing device to perform a transaction using a first payment protocol and a second payment protocol, the method including: on the mobile computing device, executing a process to communicate with a transaction platform executing a processor to associate a receipt of payment via the first payment protocol to the transaction platform with an account associated with the mobile computing device, receive from the transaction platform a temporary credential used for payment via the second payment protocol, the temporary credential funded based on the receipt of the payment to the transaction platform, contact a terminal via a communication protocol, and use the temporary credential to cause payment via the terminal.

In some embodiments, an amount for the payment may be selected by the terminal. An expiration date for the temporary credential may be selected by the mobile computerized device. In some embodiments, a link to a web server address of the transaction platform associated with the first and second payment protocols may be received by the mobile computing. In some embodiments, the link to the web server address may be generated by the terminal, and data may be transferred between a bank account associated with the first payment protocol and the transaction platform, upon access to the received link and authentication by the mobile computing device

In some embodiments, a payment credential may be received from a first issuer, and at least one second issuer may be selected to generate the temporary credential, based on terms offered by multiple issuers and in accordance with the received payment credential. In some embodiments, a payment credential may be received from a first issuer, and at least one acquirer may be selected to facilitate acquiring of transactions via the terminal, based on terms offered by multiple acquirers and in accordance with the received payment credential.

There is thus provided, in accordance with some embodiments, a system for performing transactions by a mobile computing device, using a first payment protocol and a second payment protocol, the system including a transaction platform, in communication with the mobile computing device, the transaction platform executing a processor to associate a receipt of payment via a first payment protocol to the transaction platform with an account associated with the mobile computing device, and send a temporary credential used for payment via the second payment protocol, wherein the temporary credential is based on the receipt of the payment to the transaction platform, and a terminal, in communication with the mobile computing device via a communication protocol. In some embodiments, the terminal may be configured to use the temporary credential to cause payment via the terminal.

In some embodiments, the system may further include a database, in communication with the terminal, wherein the database comprises a list of confirmed bank accounts for transactions with the temporary credential. In some embodiments, the mobile computing device may be configured to select an amount for the payment prior to receipt of the temporary credential.

In some embodiments, the transaction platform may be configured to execute a processor to select an expiration date for the temporary credential. In some embodiments, the mobile computing device may be configured to receive a link to a web server address of the transaction platform associated with the first and second payment protocols, and wherein the terminal may be configured to generate the link to the web server address.

There is thus provided, in accordance with some embodiments, a method of enabling a mobile computing device to perform a transaction, the method including on the mobile computing device, communicating with a transaction platform to: associate a receipt of payment to the transaction platform from the mobile computing device with an account associated with the mobile computing device, receive from the transaction platform a temporary credential used for payment, the temporary credential based on the receipt of the payment to the transaction platform, and on a terminal, use the temporary credential to cause payment via the terminal.

In some embodiments, an amount for the payment may be selected by the terminal. A link to a web server address of the transaction platform associated with first and second payment protocols may be received by the mobile computing device. In some embodiments, the link to the web server address may be generated by the terminal, and data may be transferred between a bank account associated with the first payment protocol and the transaction platform, upon access to the received link.

In some embodiments, an expiration date for the temporary credential may be selected by the mobile computerized device. In some embodiments, a payment credential may be received from a first issuer, and at least one second issuer may be selected to generate the temporary credential, based on terms offered by multiple issuers and in accordance with the received payment credential. In some embodiments, a payment credential may be received from a first issuer, and at least one acquirer may be selected to facilitate acquiring of transactions via the terminal, based on terms offered by multiple acquirers and in accordance with the received payment credential. In some embodiments, cryptographically protected information regarding at least one of an issuer and an acquirer registered on a distributed ledger may be retrieved by the transaction platform, wherein the payment via the terminal may be carried out with a trustless transaction based on the retrieved information

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows a block diagram of an examplary computing device, according to some embodiments of the invention;

FIG. 2A shows a block diagram of a transaction system, according to some embodiments of the invention;

FIG. 2B shows another block diagram of the transaction system, according to some embodiments of the invention;

FIG. 3 shows a flowchart for a method of a generating a temporary consumer account, according to some embodiments of the invention; and

FIG. 4 shows a flowchart for a method of enabling a mobile computing device to perform a transaction using a first protocol and a second protocol, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

According to some embodiments, methods and systems are provided for enabling performance of transactions between consumers and merchants, using computing devices that carry out transactions via a first payment protocol and a second payment protocol (e.g., when the merchant cannot accept payments via the first payment protocol and/or method). In some embodiments, a consumer's mobile computing device may communicate with an external platform (e.g., operating on an external server) that may associate a receipt of payment from the consumer's mobile computing device to the platform via the first payment protocol to the consumer, so as to later enable transactions with a merchant's computing device that may allow transfer of payments via the second payment protocol from the consumer to the merchant.

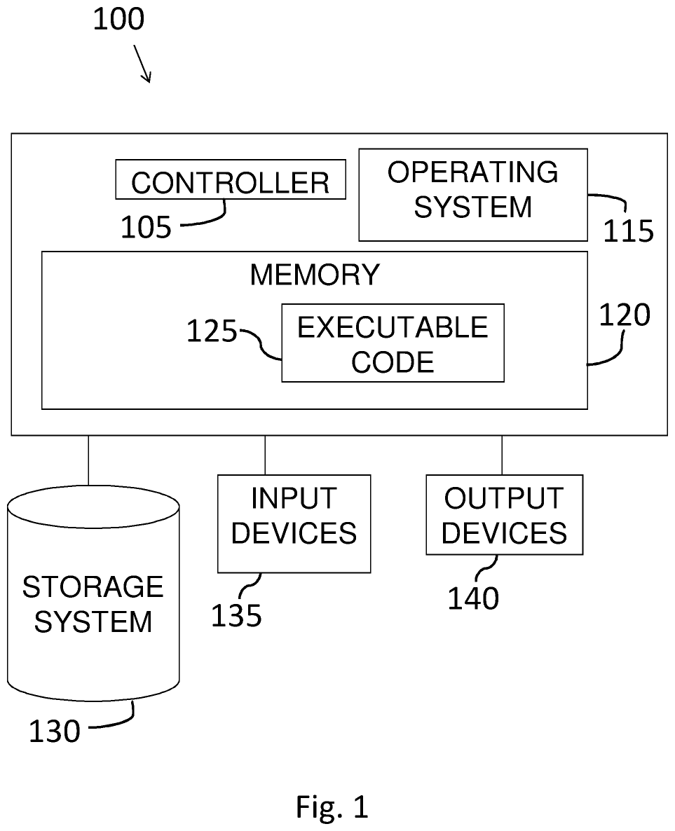

Reference is made to FIG. 1, which shows a block diagram of an examplary computing device, according to some embodiments of the invention. A device 100 may include a controller 105 that maybe, for example, a central processing unit processor (CPU), a chip or any suitable computing or computational device, an operating system 115, a memory 120, executable code 125, a storage system 130 that may include input devices 135 and output devices 140. Controller 105 (or one or more controllers or processors, possibly across multiple units or devices) may be configured to carry out methods described herein, and/or to execute or act as the various modules, units, etc. More than one computing device 100 may be included in, and one or more computing devices 100 may act as the components of, a system according to embodiments of the invention.

Operating system 115 may be or may include any code segment (e.g., one similar to executable code 125 described herein) designed and/or configured to perform tasks involving coordination, scheduling, arbitration, supervising, controlling or otherwise managing operation of computing device 100, for example, scheduling execution of software programs or tasks or enabling software programs or other modules or units to communicate. Operating system 115 may be a commercial operating system. It will be noted that an operating system 115 may be an optional component, e.g., in some embodiments, a system may include a computing device that does not require or include an operating system 115. For example, a computer system may be, or may include, a microcontroller, an application specific circuit (ASIC), a field programmable array (FPGA) and/or system on a chip (SOC) that may be used without an operating system.

Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of, possibly different memory units. Memory 120 may be a computer or processor non-transitory readable medium, or a computer non-transitory storage medium, e.g., a RAM.

Executable code 125 may be any executable code, e.g., an application, a program, a process, task or script. Executable code 125 may be executed by controller 105 possibly under control of operating system 115. For example, executable code 125 may be an application that enables performing transactions between computing devices. Although, for the sake of clarity, a single item of executable code 125 is shown in FIG. 1, a system according to some embodiments of the invention may include a plurality of executable code segments similar to executable code 125 that may be loaded into memory 120 and cause controller 105 to carry out methods described herein.

Storage system 130 may be or may include, for example, a flash memory as known in the art, a memory that is internal to, or embedded in, a micro controller or chip as known in the art, a hard disk drive, a universal serial bus (USB) device or other suitable removable and/or fixed storage unit. Content may be stored in storage system 130 and may be loaded from storage system 130 into memory 120 where it may be processed by controller 105. In some embodiments, some of the components shown in FIG. 1 may be omitted. For example, memory 120 may be a non-volatile memory having the storage capacity of storage system 130. Accordingly, although shown as a separate component, storage system 130 may be embedded or included in memory 120.

Input devices 135 may be or may include any suitable input devices, components or systems, e.g., a touch screen, detachable keyboard or keypad, a mouse and the like. Output devices 140 may include one or more (possibly detachable) displays or monitors, speakers and/or any other suitable output devices. Any applicable input/output (I/O) devices may be connected to computing device 100 as shown by blocks 135 and 140. For example, a wired or wireless network interface card (NIC), a universal serial bus (USB) device or external hard drive may be included in input devices 135 and/or output devices 140. It will be recognized that any suitable number of input devices 135 and output device 140 may be operatively connected to computing device 100 as shown by blocks 135 and 140. For example, input devices 135 and output devices 140 may be used by a technician or engineer in order to connect to a computing device 100, update software and the like.

Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, a storage medium such as memory 120, computer-executable instructions such as executable code 125 and a controller such as controller 105.

The storage medium may include, but is not limited to, any type of disk including magneto-optical disks, semiconductor devices such as read-only memories (ROMs), random access memories (RAMs), such as a dynamic RAM (DRAM), erasable programmable read-only memories (EPROMs), flash memories, electrically erasable programmable read-only memories (EEPROMs), magnetic or optical cards, or any type of media suitable for storing electronic instructions, including programmable storage devices.

Embodiments of the invention may include components such as, but not limited to, a plurality of central processing units (CPU) or any other suitable multi-purpose or specific processors or controllers (e.g., controllers similar to controller 105), a plurality of input units, a plurality of output units, a plurality of memory units, and a plurality of storage units. A system may additionally include other suitable hardware components and/or software components. In some embodiments, a system may include or may be, for example, a personal computer, a desktop computer, a mobile computer, a laptop computer, a notebook computer, a terminal, a workstation, a server computer, a Personal Digital Assistant (PDA) device, a tablet computer, a network device, or any other suitable computing device.

In some embodiments, a system may include or may be, for example, a plurality of components that include a respective plurality of central processing units, e.g., a plurality of CPUs as described, a plurality of CPUs embedded in an on board, or in-vehicle, system or network, a plurality of chips, FPGAs or SOCs, a plurality of computer or network devices, or any other suitable computing device. For example, a system as described herein may include one or more devices such as computing device 100.

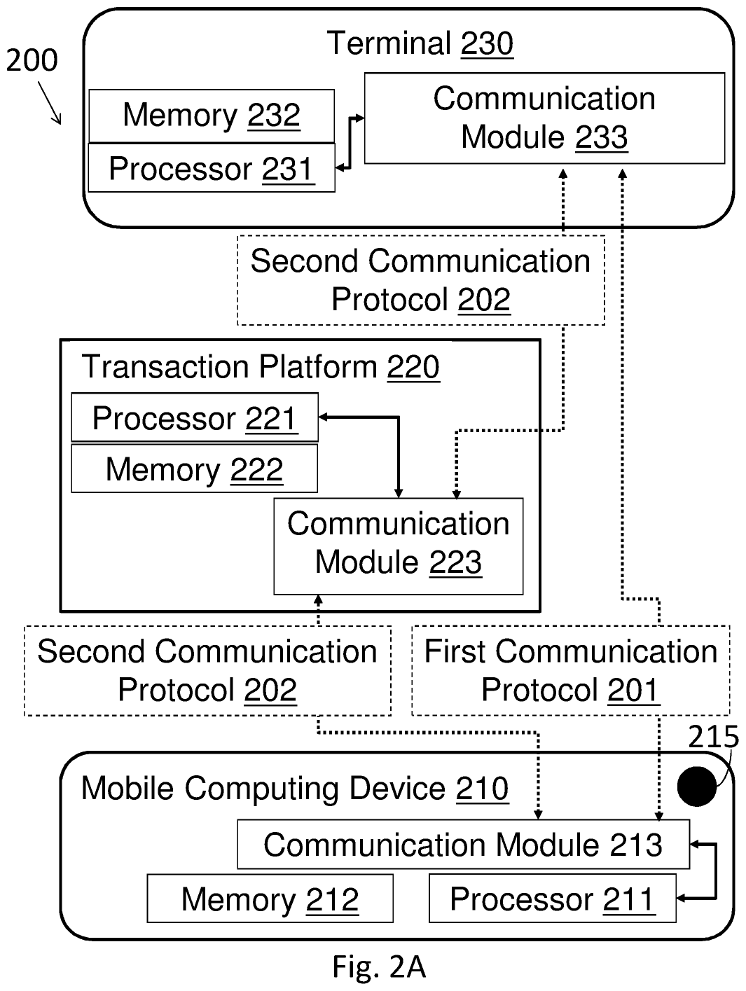

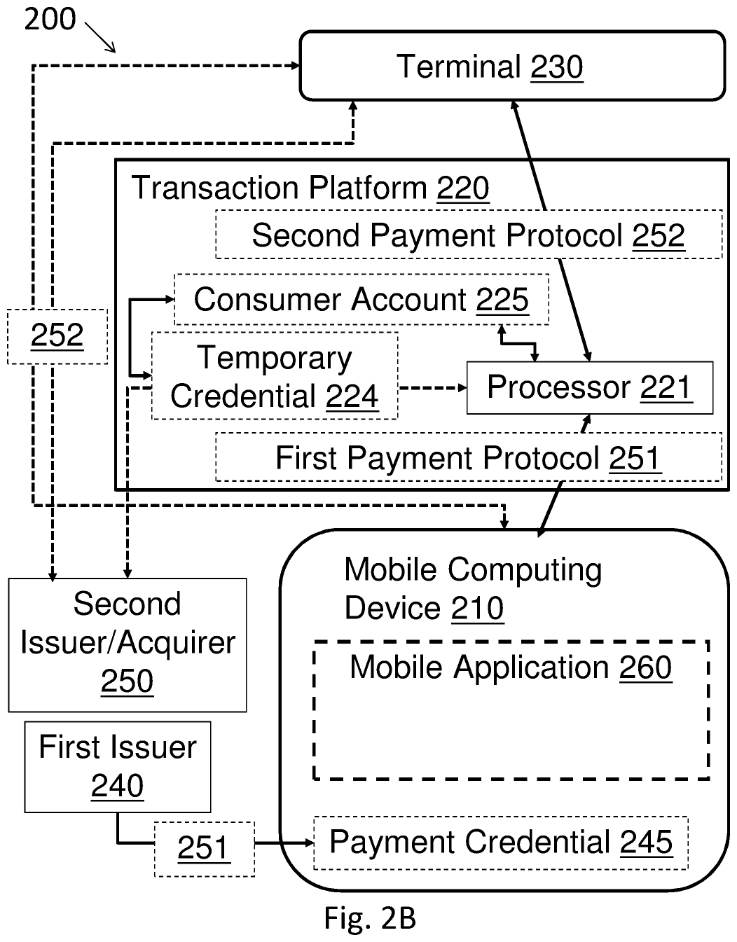

Reference is made to FIGS. 2A-2B, which show block diagrams of a transaction system 200, according to some embodiments of the invention. The direction of arrows in FIG. 2 may in some embodiments indicate the direction of information flow. In some embodiments, hardware elements of the transaction system 200 may be indicated with a solid line and software elements may be indicated with a dashed line. Software elements may be executed by hardware elements, e.g. a controller/processor as described in FIG. 1.

According to some embodiments, transaction system 200 may enable a user of a mobile computing device 210 to perform a transaction with another party using an intermediate transaction platform 220. For example, a consumer may enter a small business (e.g., a shop or restaurant) and would like to make a cashless payment where the business may not accept the payment method (e.g., international credit card and/or international debit card) currently accessible by the consumer. The consumer may use the transaction system 200 in order to carry out a payment to a merchant of the small business. The consumer's mobile computing device 210 may communicate with a terminal 230 of the merchant via a first communication protocol 201 configured to enable communication between nearby computing devices (e.g., the contactless Bluetooth and/or NFC protocol). According to some embodiments, at least one of the mobile computing device 210 and the terminal 230 (e.g., a tablet) may communicate with the transaction platform 220 (e.g., on an external server) via a second communication protocol 202 configured to enable communication between computing devices (e.g., via the internet).

Communication between the mobile computing device 210 and the transaction platform 220, via the first communication protocol 201, may be carried out via dedicated communication modules 213 and 233. Similarly, communication between the mobile computing device 210 or terminal 230 and the transaction platform 220, via the second communication protocol 202, may be carried out via dedicated communication modules 213, 233, 223 respectively. The mobile computing device 210 may include a processor 211 to control the communication module 213, and a corresponding memory unit 212. The transaction platform 220 may include a processor 221 (such as controller 105 shown in FIG. 1) to control the communication module 223, and a corresponding memory unit 222. The terminal 230 may include a processor 231 to control the communication module 233, and a corresponding memory unit 232.

According to some embodiments, consumers, or users of the transaction system 200, may operate a mobile computing device 210 (e.g., smartphone, smartwatch, tablet, IoT device, etc.) and at least one cashless payment method at their disposal, such as a credit card which may be foreign to or not useable to a local merchant (local to where the consumer is currently), and/or a bank account, and/or an online eWallet, associated with the mobile computing device 210. If the merchant is unable to receive payments via the at least one cashless payment method of the consumer (e.g., since the consumer's financial accounts and payment methods are based in a first country, and the merchant and the merchant's payment methods and bank are in a second country), the consumer may transfer a payment to the merchant via a dedicated transaction platform 220 of the transaction system 200.

Reference is now made to FIG. 2B. It should be noted that FIG. 2A schematically illustrates example communication protocols used between the mobile computing device 210, transaction platform 220 and terminal 230 in the transaction system 200, while FIG. 2B schematically illustrates example payment protocols used between the mobile computing device 210, transaction platform 220 and terminal 230 in the transaction system 200. Some elements of the mobile computing device 210, transaction platform 220 and terminal 230 that are shown in FIG. 2A are not be shown in FIG. 2B, and vice versa.

A first payment protocol 251 and a second payment protocol 252 may be used as payment methods to carry out transactions within the transaction system 200. The consumer's mobile computing device 210 may carry out transactions via the first payment protocol 251 (e.g., the EMV protocol) while the merchant's terminal 230 may only receive payments via the second payment protocol 252. In some embodiments, at least one first payment protocol 251 and/or second payment protocol 252 may include a payment instrument issuing protocol utilizing transport layer security for authentication, for instance a protocol for secure communication between computing devices and bank servers such that the payment protocol may carry payment information. The first and second payment protocols 251, 252 may allow issuers and/or acquirers (e.g., banks) to provide tools that allow for securely transferring data and/or payments between the mobile computing device 210, the transaction platform 220 and the terminal 230.

The mobile computing device 210 may receive payment information created by a first issuer 240 (e.g., a bank), including payment information (e.g., details of a bank account and/or a credit card) issued by the first issuer 240 and associated with the consumer. For example, a user may receive a credit card not usable in a certain local jurisdiction and enter via keyboard the credit card into mobile computing device 210. In order to perform a cashless transaction with the terminal 230, the consumer may request (e.g., via a dedicated app 260 at mobile computing device 210) that transaction platform 220 organize or request that a second issuer and/or acquirer 250 (e.g., a bank) to issue a temporary credential 224, such as a virtual local (e.g., within a nation) prepaid card and/or debit card, typically useable in specific jurisdiction different from or narrower than the jurisdiction in which payment credential 245 (issued by the first issuer 240) is useable, for the transaction platform 220. The transaction platform 220 may communicate with the second issuer and/or acquirer 250 to utilize the payment instrument issuing protocol to issue the temporary credential 224 (e.g., with a dedicated card number) for the mobile computing device 210, such that data transfer between the mobile computing device and the second issuer 250 may be carried out only via the transaction platform 220. The temporary credential 224, for example a virtual debit card, may be stored on the mobile computing device 210 with its balance maintained by the second issuer 250 and the transaction platform 220 may commit and/or transfer funds to the second issuer 250 which may originate from the consumer's account at the first issuer 240. The second issuer and/or acquirer 250 may provide a temporary payment credential (e.g. 224), e.g. a debit card, which is accepted in a local jurisdiction and which operates via a local payment method, e.g. payment protocol 252. Transaction platform 220 may maintain a consumer account 225 associated with the user and/or the user's mobile computing device 210, for instance funded via the first payment protocol 251, which is a protocol typically not accepted in a local jurisdiction where second payment protocol 252 is accepted, or a protocol not accepted by the merchant due to lack of supporting infrastructure. Consumer account 225 may be used by transaction platform 220 to fund a temporary payment credential issued or created by for example issuers/acquirers 250. The consumer may use a mobile application 260, associated with the consumer account 225, to fund the temporary credential 224 by a predetermined amount (e.g., 100 US dollars) and the transaction platform 220 may update that amount in the dedicated consumer account 225 for future purchases (e.g., similarly to eWallets). In some embodiments, the initiation of payment may be carried out by the consumer (e.g., the holder of the payment instrument). The consumer may perform payment via the first payment protocol 251 and second payment protocol 252; this process may be initiated by the user for example by scanning QR code, or receiving a code via NFC leading to or pointing to payment platform 220, e.g. via the internet or an App store or download.

Thus, transaction system 200 may allow the consumer to use the mobile computing device 210 with the consumer account 225 to carry out a transaction with the merchant's terminal 230. In some embodiments, the first issuer 240 and the second issuer 250 may be the same issuer (e.g., a different branch of the same bank, possibly located in different jurisdictions; or the same bank issuing credit cards as well as local debit cards). It should be noted that while only two issuers are shown in FIG. 2B, any number of issuers may communicate with at least one of mobile computing device 210, the transaction platform 220 and the terminal 230 to offer their service until the second issuer 250 may be selected for each transaction (e.g., selected in accordance with transaction terms that they offer).

In some embodiments, the terminal 230 may communicate with the second issuer and/or acquirer 250 in order to receive confirmations that payments were successfully carried out between the temporary credential 224 of transaction platform 220 and the terminal 230, via the second payment protocol 252.

According to some embodiments, terminal 230 may transmit a dedicated link (e.g., a URL) to mobile computing device 210 via the first (contactless) communication protocol 201 (e.g., Bluetooth, WiFi, NFC, etc.), and/or display the link on a terminal's 230 display in a format that may be optically scanned by the supporting consumer's mobile computing device 210 (e.g., scan a QR code or bar code by an imager 215). The link may be a link to a web server associated with or including the transaction platform 220, such that the merchant may utilize the terminal 230 to cause the consumer to follow the link to the transaction platform 220 in order to carry out the payment. Thus, even when the only communication between the mobile computing device 210 and the terminal 230 is possible via the first communication protocol 201, the transaction platform 220 may utilize other payment protocols in order to carry out transactions therebetween.

According to some embodiments, the consumer may use the mobile computing device 210 to follow the link to the transaction platform 220 in order to install (e.g., by processor 211) dedicated software (e.g., a mobile application) 260 to facilitate payment operations with the transaction platform 220 and/or terminal 230. Software 260 may for example, allow for user input to provide payment to a service that operates transaction platform 220, receive and/or store payment credentials (e.g., a virtual debit card acceptable by local merchants), and use the payment credentials to pay a merchant using, for example communications protocol 201. Other methods of allowing a mobile computing device to communicate with a server and/or a merchant may be used: for example a native app, or native software, on the mobile device, or a web browser, may be used.

According to some embodiments, in order to facilitate a consumer-merchant transaction, the mobile computing device 210 may execute a process (e.g., via software or app 260) to interact with the transaction platform 220, for instance via the first payment protocol 251 so as to facilitate a payment from the user to the service operating transaction platform 220. The transaction platform 220 may accordingly, by executing processor 221 associate receipt of payments (e.g., via the user entering information at mobile computing device 210) to the transaction platform 220 via the first payment protocol 251 with the mobile computing device 210.

According to some embodiments, the mobile computing device 210 may receive from the transaction platform 220 a temporary credential 224 (e.g., virtual prepaid card or debit card) to be used for payment via the second payment protocol 252, for instance a payment protocol used for or as local debit card payments. The temporary credential 224 may be created, and funded based on receipt of payment to the transaction platform 220 associated with the mobile computing device 210 (e.g., funded from a bank account at first issuer 240). The temporary credential 224 may be created by the second issuer and/or acquirer 250, and provided by the transaction platform 220 to the mobile computing device 210, in order to facilitate a future transaction with the merchant or other local merchants. The temporary credential 224 may be created with terms specific to the enterprise controlling terminal 230 (e.g., specific to the type/location of business) and also based on available funds based on the payment credential 245 (e.g., available funds of consumer's bank account).

In some embodiments, he transaction platform 220 may receive from the second issuer 250 the temporary credential 224 as a set of cryptographic keys and data fields, usually referred to as “personalization data”, for instance as a superset of keys and data values required to initiate payment via any supported payment protocol (e.g., prescribed by the “EMV” protocol). The transaction platform 220 may forward the temporary credential 224 securely to the mobile computing device 210, without storing the temporary credential 224 at the transaction platform 220. In other embodiments, temporary credential 224 may be represented by different data or formats.

According to some embodiments, the process of performing a cashless transaction between the consumer and the merchant may include the consumer linking the mobile computing device 210 with the payment credential 245 (e.g., eWallet), for instance the payment credential 245 may be stored in the mobile computing device 210, in order to allow future payments. Linking may include a consumer typing a credit card number associated with payment credential 245 into mobile computing device 210. The consumer may receive a link (e.g., optically scan a QR code) from the merchant's terminal 230 and register with dedicated software (e.g., register in a web service), of the transaction platform 220, the temporary credential 224 in accordance with the second issuer 250, for example the consumer may select (e.g., from a list) the second issuer 250 to be a bank offering favorable exchange rate terms. Thus, in some embodiments a consumer's mobile computing device 210 may communicate with a merchant terminal 230 using a first method (e.g., optically scanning a QR code to automatically connect with a web server of the transaction platform 220) to start the creation of a temporary payment method, and using a second method (e.g., second payment protocol 252) to communicate payment back to terminal 230.

According to some embodiments, the transaction platform 220 may use the temporary credential 224 to cause payment via the terminal 230, for instance communicating directly with terminal 230 via the second payment protocol 252 to carry out a transaction that is acceptable by the merchant.

The merchant may use the terminal 230 to generate a dedicated link (e.g., a QR code or a barcode or a URL) for the consumer. The link may be generated by the transaction platform 220 and transferred to the terminal 230, for instance via the second communication protocol 202. In some embodiments, the generated link may be transferred by the terminal 230 to the mobile computing device 210 via a contactless protocol (e.g., NFC) so as to allow the consumer to access the generated link.

According to some embodiments, the merchant may display the link to the consumer with a scannable physical and/or printed link to be optically scanned by an optical element (e.g., by the imager 215, shown in FIG. 2A) of the mobile computing device 210 and thereby allow the consumer to access the transaction platform 220 by accessing the link (e.g., accessing a link to a web server and/or downloading dedicated software components), for instance to enable registration and additional functions (e.g., selection of payment type) to complete the transaction. In case that the consumer scans and/or receives the link (e.g., via the mobile computing device 210) from a physical and/or printed link (in contrast to a digital link on terminal 230), the confirmation of payment may be carried via the terminal 230. The terminal 230 may be connected to additional cashless payment systems in parallel to the transaction platform 220, such that some consumers may use their debit cards (e.g., pre-paid) while other consumers, such as tourists (without local debit cards), may use the transaction system 200 in order to carry out the desired transaction.

According to some embodiments, the link may be uniquely generated for each new transaction with data associated with one or more of the time/date of transaction, the amount to be payed, the place of transaction (e.g., flower shop in Amsterdam). The temporary credential 224 may include at least one offered term (e.g., exchange rate and/or fees) from the second issuer/acquirer 250 for the transaction between the consumer and the merchant.

In some embodiments, the transaction may be completed with the merchant unaware of the consumer's interaction with the transaction platform 220 since the merchant receives a payment as if it is received from a local account in a protocol acceptable by the merchant, such that there may be no need to install dedicated software at the terminal 230.

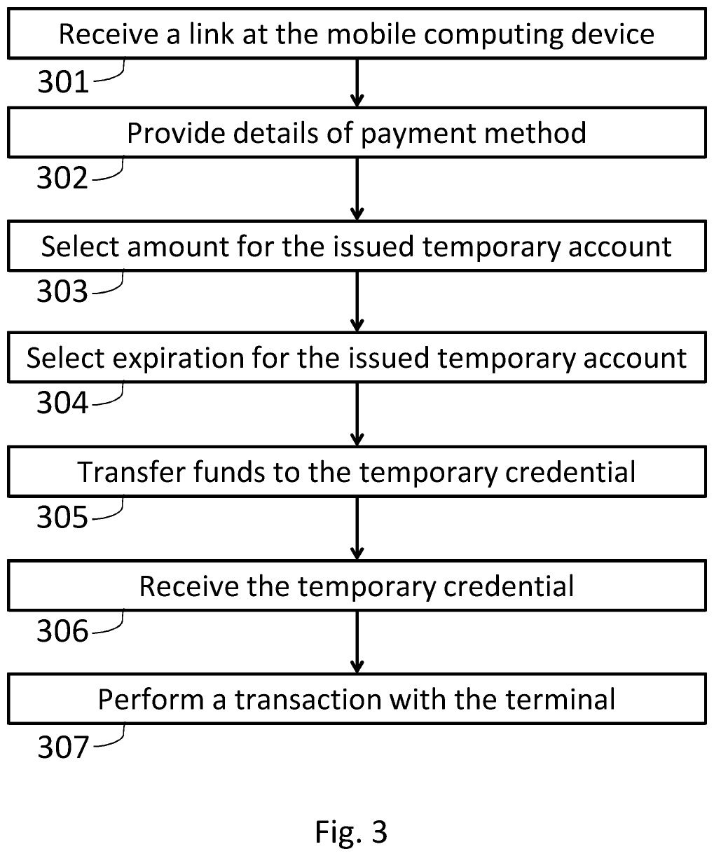

Reference is made to FIG. 3, which shows a flowchart for a method of a generating a temporary consumer account, according to some embodiments of the invention. The consumer may use the mobile computing device 210 to receive (and/or scan) the link 301 and thereby access an enrollment page of the transaction platform 220 to complete an initial registration and install dedicated software (e.g., a smartphone app 260 for the transaction platform). During enrollment, consumers may provide their cashless payment method 302 (e.g., provide details for an international credit card and/or a bank account) and select a transaction amount 303. For example, at least one of the following details may be registered for each consumer (and/or group of consumers): such as their primary account type (e.g., credit card and/or bank account), owning bank, location of the bank and/or the consumer, settlement currency, as well as merchant location, type of merchant business, amount and currency of transaction. In some embodiments, different transactions may receive different offerings by the transaction platform 220 in accordance with the details of the transaction, for example in the case of a tourist visiting a casino versus a consumer at a restaurant. According to some embodiments, multiple issuers (e.g., banks) may offer to provision or issue a temporary credential (e.g., a virtual debit card similar to a local prepaid card) for the location of the consumer and/or merchant (e.g., a flower shop) such that the offer with best conditions for the consumer and/or merchant may be selected.

According to some embodiments, the consumer may be issued, by the transaction platform 220, a temporary debit card (that is acceptable by the merchant) to complete the transaction. The consumer may select (e.g., during enrollment) if the issued card and/or temporary consumer account is for the exact amount of a particular transaction, and/or a higher amount (thus being available for later use) 303. In some embodiments, the consumer may select if the issued temporary debit card and/or temporary consumer account is for one-time use or if it remains available for later use, with the same merchant or with other merchants. The consumer may also select an expiration date for issued temporary debit card and/or temporary consumer account 304. It should be noted that the issued temporary debit card and/or temporary consumer account that is issued by the transaction platform 220 may be virtual and/or electronic such that the consumer may transfer funds to the newly created temporary card and/or consumer account and the merchant may receive the funds as if it was a regular local card and/or account.

According to some embodiments, the temporary debit card and/or temporary consumer account may be issued at terms that are favorable to the consumer, for instance from a set of offerings (e.g., exchange rates, fees, etc.) by available issuer banks. The transaction platform 220 may include a database with a list of available issuer banks and corresponding available offerings for issuing temporary debit cards and/or temporary consumer accounts, such that the consumer may select a desired option for one or more transactions. In some embodiments, the transaction platform 220 may (automatically) select a prioritized list of payment instruments, for instance sorted by degree of favorability of terms for a particular interaction between the consumer and the merchant. For example, the list may be composed based on predefined catalog of payment instruments previously provided by issuers and/or may be generated using real-time queries to issuer banks.

According to some embodiments, the consumer may transfer funds to (or “top-up”) 305 the issued temporary debit card and/or temporary transaction credential using at least one of the cashless payment method provided by the consumer during enrollment 301 (e.g., credit cards, debit cards, bank transfer, eWallets, etc.). The issued temporary debit card and/or temporary transaction credential may be generated by the transaction platform 220 and transferred 306 (e.g., via internet connection) to the dedicated software of the mobile computing device 210. The temporary debit card and/or temporary transaction credential may be generated by interacting with a selected issuer (e.g., an issuer bank selected from a list, such as second issuer 250) to generate the payment instrument to be acceptable by the merchant.

In some embodiments, the generated temporary debit card and/or temporary consumer account may enable transactions between the mobile computing device 210 and the terminal 230 via the second payment protocol 252, without the need for the intermediate transaction platform 220.

In some embodiments, the consumer may use the transferred temporary debit card and/or temporary consumer account at the mobile computing device 210 and perform a transaction 307 (e.g., a contactless transaction) with the merchant's terminal 230.

According to some embodiments, the transaction platform 220 may also facilitate acquiring of the transaction at terms favorable to the merchant, from a set of offerings by acquirer banks. For example, in case that the consumer has cashless method of payment that is accepted by the merchant (e.g., a local debit card), the merchant may use the transaction platform 220 to achieve favorable acquiring terms for a transaction received from the consumer e.g., with an acquirer bank, such as lower fees, better exchange rates, cost, funding cycle length and delay, currency rate mark-up, decline propensity, shorter settlement cycles, as well as pre-entered merchant preference. The consumer may not be aware of the acquiring terms achieved by the merchant and only see the final transaction offer. In some embodiments, at least one issuer and/or acquirer may provide information regarding the set of payment instruments available and/or suggested for the particular transaction and/or consumer. At least one acquirer may be selected (e.g., by the merchant and/or by the transaction platform 220) to facilitate acquiring of transactions via the terminal, for instance based on terms offered by multiple acquirers.

According to some embodiments, a consumer may initiate issuing of a temporary debit card or temporary transaction credential without interaction with merchant-side of the transaction platform 220. The merchant may process a standard contactless transaction with an existing payment scheme provided by the consumer and being unaware of the interaction between the consumer and the transaction platform 220, for example if the consumer is registered with a multi-use temporary transaction credential (e.g., a prepaid card) and then uses the new payment instrument at a separate merchant. The merchant may in some embodiments acquire the transaction as a standard-compliant (e.g., “EMV”) contactless transaction, while the consumer may use a standard payment card or app and may not be aware of the transaction platform 220, while the merchant may acquire at favorable terms offered by the consumer's payment instrument (e.g., debit card).

In some embodiments, the transaction platform 220 may retrieve information about the consumer from the registered consumer's payment method in order to satisfy due-diligence and/or “know your client” checks, for instance by obtaining cryptographic data from a dedicated database and/or network.

According to some embodiments, issuers and/or acquirers may be registered with the transaction platform 220 into a “consortium” with limited level of mutual trust, being technically linked by a computer network based on distributed ledger technology (or a blockchain network). The participants, issuers and/or acquirers, may thus have shared access to a distributed, cryptographically protected database with embedded “smart contracts”, e.g., elements of business logic that limit transitions of entry statuses and control access by participating entities. The participants may support delegation of trust into such computer network such that transactions between trustless parties may be carried out, and thereby allow for instance for each participant to rely on “know your client” checks carried out by another participant. In some embodiments, a central database of issuers and/or acquirers may be embedded into the transaction platform 220 with details of the members to replace the blockchain network.

In some embodiments, issuers and/or acquirers of the “consortium” linked by a computer network based on distributed ledger technology may share limited information (e.g., regarding various consumers and/or merchants) via a dedicated protocol. Each consumer may be linked to an “owner” (a participant of the consortium) that initially performed know your customer (KYC) check on that customer. Each member of the consortium may generate and/or publish two sets of keys, for instance Enc_{sign}/Dec_{sign}, and Enc_{exchange}/Dec_{exchange}, generated under an asymmetric cryptographic protocol. Each member may distribute the Dec_{sign} and EnC_{exchange} keys via the distributed ledger for all members of the consortium, thereby allowing other members to share KYC data for example Upon completion of the KYC process, the owner may generate a unique consumer ID for the consumer. The owner may also generate a pair of keys under an asymmetric cryptographic protocol, referred to as Encₒ (the encryption key) and Decₒ (the decryption key). Full consumer details and relevant KYC documents may be encrypted using Encₒ, and signed using En_{sign}, and may be stored in the distributed ledger. In some embodiments, the transaction platform 220 may issue requests for data retrieval from the distributed ledger, for instance for a specific merchant for each issuing/acquiring process, for instance the request including the relevant consumer ID such that issuers and/or acquirers (e.g., members of the consortium) may use the ID to locate an encrypted record for this consumer and use Dec_{sign} to ensure that the record was indeed authorized by its owner. In case that a member is requested to register a new consumer, the member may post a consumer data request, signed by its Enc_{sign}, to the distributed ledger. Upon identifying a consumer data request, the owner may validate its source by using the Dec_{sign} that corresponds to the particular member, and encrypt Decₒ with Enc_{exchange}, to sign it with its Enc_{sign} and post it to the distributed ledger. The corresponding member may use the owner's Dec_{sign} and its own Dec_{exchange} to validate and decrypt the original customer data on the distributed ledger.

For example, a certain bank may perform a due diligence check of a particular merchant, checking its legal status, verifying that no illicit activities take place, as well as identifying the merchant's industry. The bank may place encrypted details of the merchant in the distributed ledger and publish a unique ID that would identify this merchant record and confirm that full KYC process had been performed for it. During an acquiring process, the transaction platform 220 may identify the merchant by its unique ID and communicate it to all bidding acquirers, who may then be able to verify that due to the known KYC checks for this entity, that has been completed by an acquirer and that a particular evidence record is present in their local copy of the distributed ledger. In case that an acquirer of a transaction is to be selected (e.g., in a bidding) the winning acquirer may rely on KYC checks performed by another member of the consortium and provide acquiring services to the merchant instantly. The acquirer may be able to retrieve full details of the merchant by posting details of the transaction to the distributed ledger and receiving a decryption key for the merchant details in response. Similarly, if an issuer, of a debit card for instance, is to be selected (e.g., in a bidding) the winning issuer may rely on KYC checks (with consumer details being handled instead of merchant details) performed by another member of the consortium and provide issuing services to the consumer instantly. Thus, the transaction platform 220 may retrieve cryptographically protected information regarding an issuer and/or an acquirer registered on the distributed ledger, wherein the payment via the terminal 230 may be carried out with a trustless transaction based on the retrieved information (due to the KYC).

At least one of the consumer-side and merchant-side of the transaction system 200 may be required to complete a transaction. For instance, a consumer with a payment method acceptable by the merchant where the transaction is acquired (e.g., by a particular bank) only at the merchant side.

At least one dedicated software application may be embedded within issuer and/or acquirer servers so as to integrate with their incumbent systems and support the transaction platform 220, for instance to retrieve details about available acquirers.

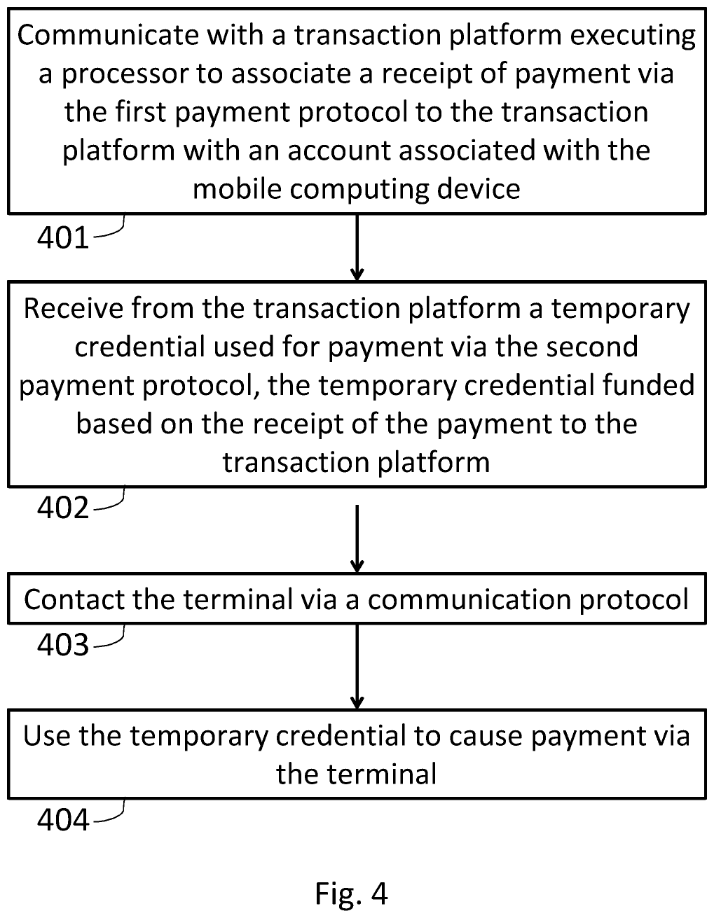

Reference is made to FIG. 4, which shows a flowchart for a method of enabling a mobile computing device to perform a transaction using a first payment protocol and a second payment protocol, according to some embodiments of the invention. The consumer may execute a process on the mobile computing device 210 to communicate 401 with a transaction platform 220 executing a processor 204 to associate a receipt of payment via the first payment protocol to the transaction platform 220 with an account associated with the mobile computing device 210. The mobile computing device 210 may receive 402 from the transaction platform 220 a temporary credential 224 used for payment via the second payment protocol 252, the temporary credential 224 funded based on the receipt of the payment to the transaction platform 220.

According to some embodiments, the consumer may contact 403 the terminal 230 via a communication protocol (e.g., via the first communication protocol 201) and use 404 the temporary credential 224 to cause payment via the terminal 230, for instance using the temporary credential 224.

Unless explicitly stated, the method embodiments described herein are not constrained to a particular order in time or chronological sequence. Additionally, some of the described method elements may be skipped, or they may be repeated, during a sequence of operations of a method.

Various embodiments have been presented. Each of these embodiments may of course include features from other embodiments presented, and embodiments not specifically described may include various features described herein.

1. A method of enabling a mobile computing device to perform a transaction using a first payment protocol and a second payment protocol, the method comprising:
on the mobile computing device, executing a process to:
communicate with a transaction platform executing a processor to associate a receipt of payment via the first payment protocol to the transaction platform with an account associated with the mobile computing device;
receive from the transaction platform a temporary credential used for payment via the second payment protocol, the temporary credential funded based on the receipt of the payment to the transaction platform;
contact a terminal via a communication protocol; and
use the temporary credential to cause payment via the terminal.

2. The method of claim 1, further comprising selecting, by the terminal, an amount for the payment.

3. The method of claim 1, further comprising receiving, by the mobile computing device, a link to a web server address of the transaction platform associated with the first and second payment protocols.

4. The method of claim 3, further comprising:
generating, by the terminal, the link to the web server address; and
transferring data between a bank account associated with the first payment protocol and the transaction platform, upon access to the received link and authentication by the mobile computing device.

5. The method of claim 1, further comprising selecting, by the mobile computerized device, an expiration date for the temporary credential.

6. The method of claim 1, further comprising:
receiving a payment credential from a first issuer; and
selecting at least one second issuer to generate the temporary credential, based on terms offered by multiple issuers and in accordance with the received payment credential.

7. The method of claim 1, further comprising:
receiving a payment credential from a first issuer; and
selecting at least one acquirer to facilitate acquiring of transactions via the terminal, based on terms offered by multiple acquirers and in accordance with the received payment credential.

8. A system for performing transactions by a mobile computing device, using a first payment protocol and a second payment protocol, the system comprising:
a transaction platform, in communication with the mobile computing device, the transaction platform executing a processor to associate a receipt of payment via a first payment protocol to the transaction platform with an account associated with the mobile computing device, and send a temporary credential used for payment via the second payment protocol, wherein the temporary credential is based on the receipt of the payment to the transaction platform; and
a terminal, in communication with the mobile computing device via a communication protocol;
wherein the terminal is configured to use the temporary credential to cause payment via the terminal.

9. The system of claim 8, further comprising a database, in communication with the terminal, wherein the database comprises a list of confirmed bank accounts for transactions with the temporary credential.

10. The system of claim 8, wherein the mobile computing device is configured to select an amount for the payment prior to receipt of the temporary credential.

11. The system of claim 8, wherein the transaction platform is configured to execute a processor to select an expiration date for the temporary credential.

12. The system of claim 8, wherein the mobile computing device is configured to receive a link to a web server address of the transaction platform associated with the first and second payment protocols, and wherein the terminal is configured to generate the link to the web server address.

13. A method of enabling a mobile computing device to perform a transaction, the method comprising:
on the mobile computing device, communicating with a transaction platform to:
associate a receipt of payment to the transaction platform from the mobile computing device with an account associated with the mobile computing device;
receive from the transaction platform a temporary credential used for payment, the temporary credential based on the receipt of the payment to the transaction platform; and
on a terminal, use the temporary credential to cause payment via the terminal.

14. The method of claim 13, further comprising selecting, by the terminal, an amount for the payment.

15. The method of claim 13, further comprising receiving, by the mobile computing device, a link to a web server address of the transaction platform associated with first and second payment protocols.

16. The method of claim 15, further comprising:
generating, by the terminal, the link to the web server address; and
transferring data between a bank account associated with the first payment protocol and the transaction platform, upon access to the received link.

17. The method of claim 13, further comprising selecting, by the mobile computerized device, an expiration date for the temporary credential.

18. The method of claim 13, further comprising:
receiving a payment credential from a first issuer; and
selecting at least one second issuer to generate the temporary credential, based on terms offered by multiple issuers and in accordance with the received payment credential.

19. The method of claim 13, further comprising:
receiving a payment credential from a first issuer; and
selecting at least one acquirer to facilitate acquiring of transactions via the terminal, based on terms offered by multiple acquirers and in accordance with the received payment credential.

20. The method of claim 13, further comprising retrieving, by the transaction platform, cryptographically protected information regarding at least one of an issuer and an acquirer registered on a distributed ledger, wherein the payment via the terminal is carried out with a trustless transaction based on the retrieved information.
